(19) United States
(12) Patent Application Publication
(10) Pub. No.: US 2026/0213603 A1
(43) Pub. Date: Jul. 23, 2026

(54) E-MOTOR INTEGRATED IN AXLE HOUSING

(71) Applicant: Schaeffler Technologies AG & Co. KG, Herzogenaurach (DE)

(72) Inventor: Kyle Nelson, Delaware, OH (US)

(73) Assignee: Schaeffler Technologies AG & Co. KG, Herzogenaurach (DE)

(21) Appl. No.: 19/386,744

(22) Filed: Nov. 12, 2025

Related U.S. Application Data
(60) Provisional application No. 63/721,113, filed on Nov. 15, 2024.

(51) Int. Cl. H02K 5/20; H02K 1/16; H02K 3/32; H02K 5/16

(52) U.S. Cl. CPC H02K 5/203; H02K 1/16; H02K 3/32; H02K 5/161

(57) ABSTRACT

An electric motor housing assembly includes a first housing portion, a second housing portion fixed to the first housing portion, and a stator sealed to the housing portions. The first housing portion includes a first integrated oil cavity and the second housing portion includes a second integrated oil cavity. The stator includes a first plurality of wire coils extending into the first integrated oil cavity, and a second plurality of wire coils extending into the second integrated oil cavity.

### CROSS-REFERENCE TO RELATED APPLICATIONS

This application claims the benefit of U.S. Provisional Ser. No. 63/721,113, filed Nov. 15, 2024, the disclosure of which is incorporated in its entirety by reference herein.

### TECHNICAL FIELD

The present disclosure relates generally to an e-motor, and more specifically to an e-motor integrated in an axle housing.

### BACKGROUND

E-motor stator cooling is known. One method is shown and described in commonly-assigned United States Patent Application Publication No. 2024/0258870 titled WINDING HEAD COOLING to Gramann et al., hereby incorporated by reference as if set forth fully herein.

### SUMMARY

Example aspects broadly comprise an electric motor housing assembly including a first housing portion, a second housing portion fixed to the first housing portion, and a stator sealed to the housing portions. The first housing portion includes a first integrated oil cavity and the second housing portion includes a second integrated oil cavity. The stator includes a first plurality of wire coils extending into the first integrated oil cavity, and a second plurality of wire coils extending into the second integrated oil cavity.

### BRIEF DESCRIPTION OF THE DRAWINGS

FIG. 1 illustrates a cross-sectional view of a portion of an electric motor.

FIG. 2 illustrates a cooling flow through a stator of the electric motor of FIG. 1.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

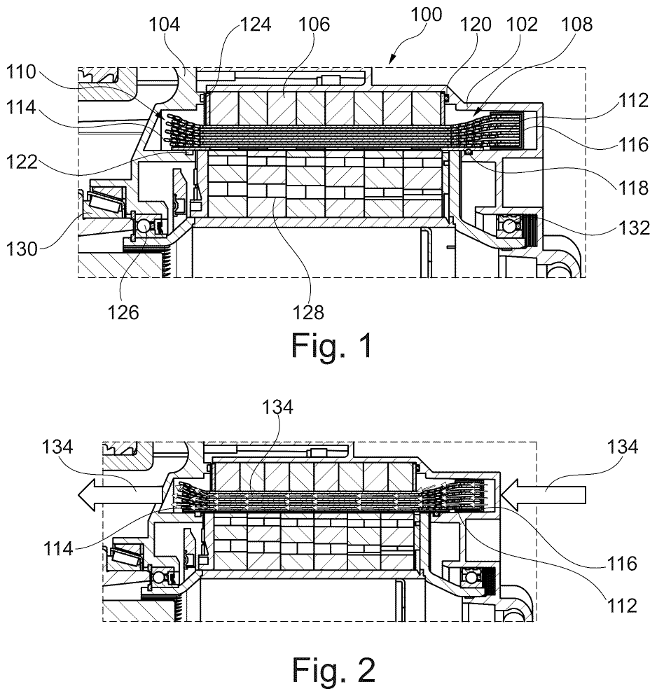

The following description is made with reference to FIGS. 1-2. FIG. 1 illustrates a cross-sectional view of a portion of an electric motor. FIG. 2 illustrates a cooling flow through a stator of the electric motor of FIG. 1. Electric motor housing assembly 100 includes housing portion 102, housing portion 104 fixed to housing portion 102, and stator 106 sealed to housing portions 102 and 104. Housing portion 102 includes integrated oil cavity 108 and housing portion 104 includes integrated oil cavity 110. Stator 106 includes wire coils 112 extending into integrated oil cavity 108, and wire coils 114 extending into integrated oil cavity 110. Housing assembly 100 also includes oil flow distributor with integrated high voltage isolators 116 surrounding wire coils 112 in integrated oil cavity 108. Stator 106 is sealed to housing portion 102 by radial seal 118 and face seal 120. Stator 106 is sealed to housing portion 104 by radial seal 122 and face seal 124.

Housing assembly 100 also includes bearing 126. Housing portion 104 forms an inner bearing wall and bearing 126 is arranged in the inner bearing wall. Bearing 126 may be a ball bearing, for example. Housing assembly 100 also includes rotor 128 rotatably mounted on bearing 126. Housing portion 104 also forms an outer bearing wall and tapered roller bearing 130 is arranged in the outer bearing wall. Housing assembly 100 also includes bearing 132 arranged in housing portion 102 and the rotor is rotatably mounted on bearing 132. Bearing 132 may be a ball bearing, for example.

As shown in FIG. 2, for example, integrated oil cavity 108 is an oil inlet cavity and integrated oil cavity 110 is an oil outlet cavity. That is, oil (indicated by arrows 134) is introduced in the inlet cavity, is distributed by distributor 116 to flow through wire coils 112 and 114, and exits the housing at the outlet cavity. Such a cooling arrangement provides a dedicated oil feed to the stator for proper function. This is sometimes referred to as DISCO (Direct Injected Slot Cooling with Oil) cooling. Housing portions 102 and 104 may be metal (e.g., aluminum) castings for example. This configuration eliminates bulky plastic oil cavities normally fixed and sealed to the housings, making the assembly more power dense.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Electric motor housing assembly
102 Housing portion (first)
104 Housing portion (second)
106 Stator
108 Integrated oil cavity (first housing portion)
110 Integrated oil cavity (second housing portion)
112 Wire coils (first plurality)
114 Wire coils (second plurality)
116 Oil flow distributor with integrated high voltage isolator
118 Radial seal (first)
120 Face seal (first)
122 Radial seal (second)
124 Face seal (second)
126 Bearing (first)
128 Rotor
130 Tapered roller bearing
132 Bearing (second)
134 Arrows (indicates oil flow)

What is claimed is:

1. An electric motor housing assembly, comprising:
a first housing portion comprising a first integrated oil cavity;
a second housing portion secured to the first housing portion and comprising a second integrated oil cavity; and
a stator, sealed to the first housing portion and the second housing portion, and comprising:
a first plurality of wire coils extending into the first integrated oil cavity; and
a second plurality of wire coils extending into the second integrated oil cavity.

2. The electric motor housing assembly of claim 1, further comprising a first bearing, wherein:
the second housing portion forms an inner bearing wall; and
the first bearing is arranged in the inner bearing wall.

3. The electric motor housing assembly of claim 2, further comprising a rotor rotatably mounted on the first bearing.

4. The electric motor housing assembly of claim 3, further comprising a second bearing arranged in the first housing portion, wherein the rotor is rotatably mounted on the second bearing.

5. The electric motor housing assembly of claim 1, wherein:
the first integrated oil cavity is an oil inlet cavity; and
the second integrated oil cavity is an oil outlet cavity.

6. The electric motor housing assembly of claim 1, wherein each of the first housing portion and the second housing portion is a metal casting.

7. The electric motor housing assembly of claim 1, wherein:
the stator is sealed to the first housing portion by a first radial seal and a first face seal; and
the stator is sealed to the second housing portion by a second radial seal and a second face seal.

8. The electric motor housing assembly of claim 1, further comprising an oil flow distributor with integrated high voltage isolators surrounding the first plurality of wire coils in the first integrated oil cavity.
